(19) United States
(12) Patent Application Publication
(10) Pub. No.: US 2025/0315375 A1
(43) Pub. Date: Oct. 9, 2025

(54) MEMORY SYSTEM AND METHOD OF SETTING DYNAMIC REFERENCE VALUE FOR INTERRUPT SIGNAL

(71) Applicant: SK hynix Inc., Gyeonggi-do (KR)

(72) Inventor: Ki Tae KIM, Gyeonggi-do (KR)

(21) Appl. No.: 19/004,466

(22) Filed: Dec. 30, 2024

(30) Foreign Application Priority Data
Apr. 9, 2024 (KR) 10-2024-0048096

(51) Int. Cl. G06F 12/02

(52) U.S. Cl. CPC G06F 12/0246

(57) ABSTRACT

Provided herein may be a memory system and a method of setting a dynamic reference value for an interrupt signal. A memory controller may include a completion signal manager configured to generate a completion signal indicating completion of an operation corresponding to a command received from a host device, and store the command in a completion queue stored in the host device in response to the completion signal, and an interrupt signal generator configured to set a dynamic reference value based on data throughput of the host device such that completion commands stored in the completion queue are processed to be complete based on the dynamic reference value, generate an interrupt signal for triggering a completion operation on the completion commands based on the dynamic reference value, and transmit the interrupt signal to the host device.

### CROSS-REFERENCE TO RELATED APPLICATION

The present application claims priority under 35 U.S.C. § 119 (a) to Korean patent application number 10-2024-0048096 filed on Apr. 9, 2024, the entire disclosure of which is incorporated by reference herein.

### BACKGROUND

### 1. Field of Invention

Various embodiments of the present disclosure relate to a memory system, and more particularly to a memory system and a method of setting a dynamic reference value for an interrupt signal used in the memory system.

### 2. Description of Related Art

A memory system includes a storage device which stores data under the control of a host device, such as a computer or a smartphone. The storage device may include a memory device in which data is stored, and a memory controller which controls the memory device. Memory devices are classified into a volatile memory device and a nonvolatile memory device.

The volatile memory device is a memory device in which data is stored only when power is supplied and in which stored data is lost when the supply of power is interrupted. Examples of the volatile memory device include a static random access memory (SRAM) and a dynamic random access memory (DRAM).

The nonvolatile memory device is a memory device in which stored data is retained even when the supply of power is interrupted. Examples of the nonvolatile memory device include a read only memory (ROM), a programmable ROM (PROM), an electrically programmable ROM (EPROM), an electrically erasable and programmable ROM (EEPROM), and a flash memory.

The memory controller may control the memory device to receive a command from the host device and perform an operation corresponding to the received command. The memory controller may transfer, to the host device, information about a command for which an operation has been completed, and may transmit, to the host device, an interrupt signal for triggering a complete operation on the command for which the operation has been completed. Data throughput of the host device may vary depending on the number of commands processed by the host device while performing the complete operation.

### SUMMARY

Various embodiments of the present disclosure are directed to a memory system for processing a completion command in response to an interrupt signal transmitted to a host device and a method of dynamically setting a reference signal for the interrupt signal used in the memory system.

An embodiment of the present disclosure may provide for a memory controller. The memory controller may include a completion signal manager configured to generate a completion signal indicating completion of an operation corresponding to a command received from a host device, and store the command in a completion queue stored in the host device in response to the completion signal, and an interrupt signal generator configured to set a dynamic reference value based on data throughput of the host device such that completion commands stored in the completion queue are processed to be complete based on the dynamic reference value, generate an interrupt signal for triggering a completion operation on the completion commands based on the dynamic reference value, and transmit the interrupt signal to the host device.

An embodiment of the present disclosure may provide for a method of operating a memory controller. The method may include generating a completion signal indicating completion of an operation corresponding to a command received from a host device, storing the command in a completion queue stored in the host device in response to the completion signal, setting a dynamic reference value based on data throughput of the host device such that completion commands stored in the completion queue are processed to be complete based on the dynamic reference value, and generating an interrupt signal for triggering a completion operation on the completion commands based on the dynamic reference value.

In the method of operating a memory controller according to an embodiment of the present disclosure, setting the dynamic reference value may include obtaining a completion count that is a number of the completion commands stored in the completion queue during a preset time interval, and generating the interrupt signal may include generating the interrupt signal in response to the completion count exceeding the dynamic reference value.

In the method of operating a memory controller according to an embodiment of the present disclosure, counting the completion count may include determining, as the completion count, a difference between a tail value of the completion queue and a head value of the completion queue, the tail value may indicate a completion command stored last in the completion queue among the completion commands, and the head value may indicate a completion command stored for a longest time in the completion queue among the completion commands.

In the method of operating a memory controller according to an embodiment of the present disclosure, setting the dynamic reference value may further include performing a counting operation for the completion count multiple times, and determining, as the dynamic reference value, an average value or a maximum value of the completion count based on a result of the counting operation.

In the method of operating a memory controller according to an embodiment of the present disclosure, setting the dynamic reference value may further include determining, as the dynamic reference value, among preset candidate values, a candidate value at which the data throughput corresponding to each of the candidate values is maximized.

In the method of operating a memory controller according to an embodiment of the present disclosure, setting the dynamic reference value may further include setting, as the completion count, a variable of the dynamic reference value, calculating a coefficient and a constant of the variable at which the data throughput is maximized through iterative attempts, and determining the dynamic reference value corresponding to the completion count based on the calculated coefficient and constant.

In the method of operating a memory controller according to an embodiment of the present disclosure, calculating the coefficient and the constant of the variable may include calculating the coefficient and the constant of the variable based on a genetic algorithm, and the genetic algorithm may determine optimal values of the coefficient and the constant of the variable using non-dominated ranking and crowding distance ranking.

In the method of operating a memory controller according to an embodiment of the present disclosure, calculating the coefficient and the constant of the variable may include calculating the coefficient and the constant of the variable based on a Bayesian optimization technique, and the Bayesian optimization technique may determine optimal values for the coefficient and the constant of the variable using an acquisition function of detecting the coefficient and the constant of the variable at which the data throughput is increased based on a surrogate model for improving the coefficient and constant of the variable based on a Gaussian process and a probability distribution of the surrogate model.

An embodiment of the present disclosure may provide for a memory system. The memory system may include a host device configured to generate a command, and including a completion queue in which completion commands for which operations have been completed are stored, a memory controller configured to receive the command and generate a control signal corresponding to the command, and a memory device configured to perform an operation corresponding to the command in response to the control signal. The memory controller may include a completion signal manager configured to generate a completion signal indicating completion of the operation corresponding to the command and store the command in the completion queue based on the completion signal, and an interrupt signal generator configured to obtain a completion count that is a number of completion commands stored in the completion queue during a preset time interval, set a dynamic reference value based on the completion count and data throughput of the host device such that the completion commands stored in the completion queue are processed to be complete based on the dynamic reference value, generate an interrupt signal for triggering a completion operation on the completion commands in response to a case where the completion count exceeds the dynamic reference value, and transmit the interrupt signal to the host device. The host device may perform the completion operation on the completion commands stored in the completion queue in response to the interrupt signal.

### BRIEF DESCRIPTION OF THE DRAWINGS

FIG. 1 is a diagram illustrating a memory system according to an embodiment of the present disclosure.

FIG. 2 is a diagram illustrating a completion operation on a command for which an operation is completed in a memory system according to an embodiment of the present disclosure.

FIG. 3 is a diagram illustrating a completion queue and a completion count according to an embodiment of the present disclosure.

FIG. 4 is a table for describing a dynamic reference value that is set based on a completion count according to an embodiment of the present disclosure.

FIG. 5 is a table for describing a method of setting a dynamic reference value based on data throughput corresponding to each candidate value according to an embodiment of present disclosure.

FIG. 6 is a diagram illustrating a method of determining a dynamic reference value using a function that uses a completion count as the variable of the dynamic reference value according to an embodiment of the present disclosure.

FIG. 7 is a flowchart illustrating a method of transmitting an interrupt signal based on a dynamic reference value according to an embodiment of the present disclosure.

FIG. 8 is a diagram illustrating a memory system including a memory controller according to an embodiment of the present disclosure.

### DETAILED DESCRIPTION

Specific structural or functional descriptions in the embodiments of the present disclosure introduced in this specification are provided as examples to describe embodiments according to the concept of the present disclosure. The embodiments according to the concept of the present disclosure may be practiced in various forms, and should not be construed as being limited to the embodiments described in the specification.

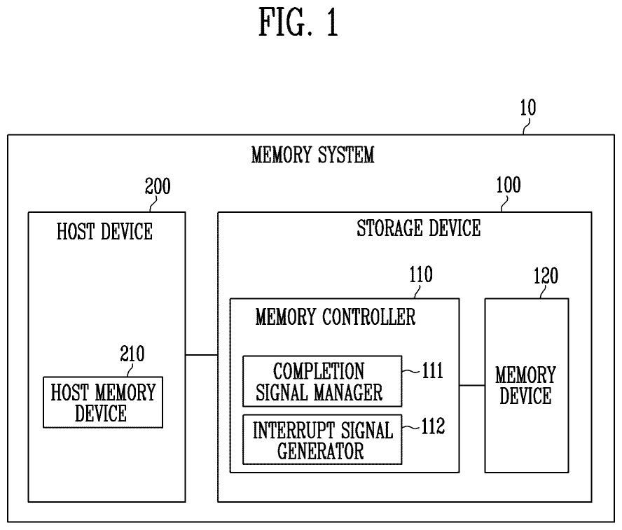

FIG. 1 is a diagram illustrating a memory system according to an embodiment of the present disclosure.

Referring to FIG. 1, a memory system 10 may include a storage device 100 and a host device 200. The storage device 100 may include a memory device 120 which performs an operation in response to a command, and a memory controller 110 which controls the overall operation of the storage device 100. The host device 200 may include a host memory device 210.

The storage device 100 may write data therein or provide written data to the host device 200 in compliance with a command from the host device 200. The storage device 100 may be implemented as a solid state drive (SSD), a multimedia card (MMC), an embedded MMC (eMMC), a secure digital (SD) card or universal flash storage (UFS), but embodiments of the present disclosure are not limited thereto.

The memory controller 110 may generate a control signal for controlling the memory device 120. The control signal may be generated based on the command or request received from the host device 200. The memory controller 110 may generate the control signal including a command and an address. The memory controller 110 may control the memory device 120 to perform a program operation, a read operation, an erase operation, or the like.

The memory device 120 may store data. The memory device 120 may be operated in response to the control signal from the memory controller 110. The memory device 120 may include a memory cell array including a plurality of memory cells which store data.

The memory device 120 may receive the control signal including the command and the address from the memory controller 110, and may access the area of the memory cell array, selected by the address. The memory device 120 may perform an operation indicated by the command on the area of the memory cell array selected by the address.

The host device 200 may run an operating system used in the memory system 10, and may execute various applications on the operating system. The host device 200 may write data to the storage device 100 or may read data written to the storage device 100.

The host device 200 may generate a command instructing operations to be performed by the memory device 120, and may transmit the generated command to the storage device 100.

In an embodiment of the present disclosure, the host device 200 may store a completion queue in which completion commands for which operations have been completed by the memory device 120 are stored. The completion queue may be stored in the host memory device 210. The host device 210 may receive a completion signal indicating each completion command from the memory controller 110. The number of completion commands stored in the completion queue may increase in response to reception of the completion signal.

The host device 200 may receive, from the memory controller 110, an interrupt signal for triggering a completion operation on the completion commands. The host device 200 may perform a completion operation of checking whether the execution of each command has been completed and deleting checked completion commands from the completion queue, in response to reception of the interrupt signal.

The memory controller 110 may include a completion signal manager 111 and an interrupt signal generator 112. The completion signal manager 111 may generate a completion signal indicating completion of an operation corresponding to each command received from the host device 200. The completion signal manager 111 may store the completion command in the completion queue in response to the completion signal.

The interrupt signal generator 112 may generate an interrupt signal to be transmitted to the host device 200. The interrupt signal generator 112 may adjust the number of completion commands stored in the completion queue by triggering the completion operation of the host device 200. The interrupt signal generator 112 may optimize the data throughput of the host device 200 by adjusting the frequency of the completion operation of the host device 200.

When the completion operation is performed whenever the completion command of the host device 200 is stored in the completion queue, resources of the host device 200 may be excessively consumed in the completion operation. The interrupt signal generator 112 may improve the efficiency of the completion operation by increasing the number of completion commands processed by the host device 200.

The interrupt signal generator 112 may generate an interrupt signal in response to the case where the number of completion commands stored in the completion queue exceeds a reference value, and may transmit the interrupt signal to the host device. The interrupt signal generator 112 may dynamically set the reference value for completion processing to efficiently perform the completion operation.

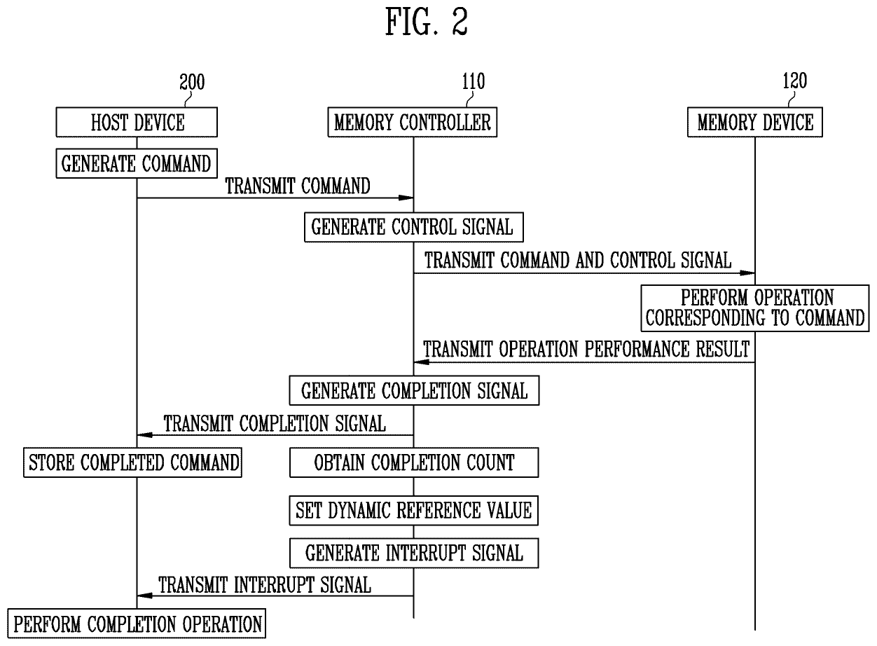

FIG. 2 is a diagram illustrating a completion operation corresponding to a command for which an operation is completed in a memory system according to an embodiment of the present disclosure.

Referring to FIG. 2, when performance of an operation corresponding to a command is completed by the memory device 120, a completion command may be stored in a completion queue. Further, the memory controller 110 may transmit an interrupt signal to the host device 200 based on the result of a comparison between a dynamic reference value, set by the memory controller 110, and the number of completion commands stored in the completion queue. Furthermore, the host device 200 may perform a completion operation on the completion commands stored in the completion queue.

Specifically, as a first operation of FIG. 2, the host device 200 may generate a command for each operation to be performed by the memory device 120, and may transmit the generated command to the storage device 100. The memory controller 110 may receive the command from the host device 200, and may generate a control signal corresponding to the command. The memory controller 110 may control the operation of the memory device 120 by transmitting the command and the control signal to the memory device 120.

The memory device 120 may perform an operation based on the command and the control signal, and may transmit the result of performing the operation (i.e., operation performance result) to the memory controller 110. The operation performance result may include information indicating whether the performance of the operation corresponding to the command has been completed. When the operation corresponding to the command is completed, the memory controller 110 may check whether the operation corresponding to the command has been completed.

The completion signal manager 111 of the memory controller 110 in FIG. 1 may generate a completion signal indicating completion of the operation corresponding to the command received from the host device 200. The completion signal manager 111 may transmit the completion signal to the host device 200 in response to the case where the operation performance result received from the memory device 120 indicates that the performance of the operation corresponding to the command has been completed. The completion signal manager 111 may store, as a completion command, the command for which the performance of the operation has been completed, in the completion queue stored in the host device 200 by transmitting the completion signal. In the completion queue, completion commands on which the completion operation is not yet performed may be stored.

The host device 200 may store, in the completion queue, the command corresponding to the received completion signal, as a completion command. The host device 200 may store the received completion commands in the completion queue until an interrupt signal for triggering the completion operation on the completion commands is received.

The interrupt signal generator 112 of the memory controller 110 in FIG. 1 may obtain a completion count indicating the number of completion commands stored in the completion queue during a preset time interval. The interrupt signal generator 112 may set a dynamic reference value based on which completion commands stored in the completion queue are processed to completion based on the completion count and the data throughput of the host device 200.

In an embodiment of the present disclosure, the interrupt signal generator 112 may obtain the completion count multiple times, and may set the dynamic reference value based on the obtained the completion counts. For example, the interrupt signal generator 112 may determine, as the dynamic reference value, the average value or maximum value of the completion counts.

In an embodiment of the present disclosure, the interrupt signal generator 112 may determine, as the dynamic reference value, a candidate value at which the data throughput of the host device 200 is maximized among preset candidate values. The interrupt signal generator 112 may temporarily set a reference value, and may check data throughput corresponding to each of the candidate values during the runtime of the memory system 10. A candidate value at which the highest data throughput is obtained may be determined to be the dynamic reference value. In response to variation in data throughput corresponding to each of the candidate values during the runtime of the memory system 10, the interrupt signal generator 112 may change the dynamic reference value.

In an embodiment of the present disclosure, the interrupt signal generator 112 may determine the dynamic reference value using a function that uses the completion count as the variable of the dynamic reference value. The interrupt signal generator 112 may calculate a coefficient and a constant of the function based on a genetic algorithm or a Bayesian optimization technique.

The interrupt signal generator 112 may generate an interrupt signal in response to the completion count exceeding the dynamic reference value. The interrupt signal generator 112 may transmit the generated interrupt signal to the host device 200.

The host device 200 may perform a completion operation on the completion commands stored in the completion queue in response to reception of the interrupt signal. When the completion operation is performed, the completion commands stored in the completion queue may be deleted.

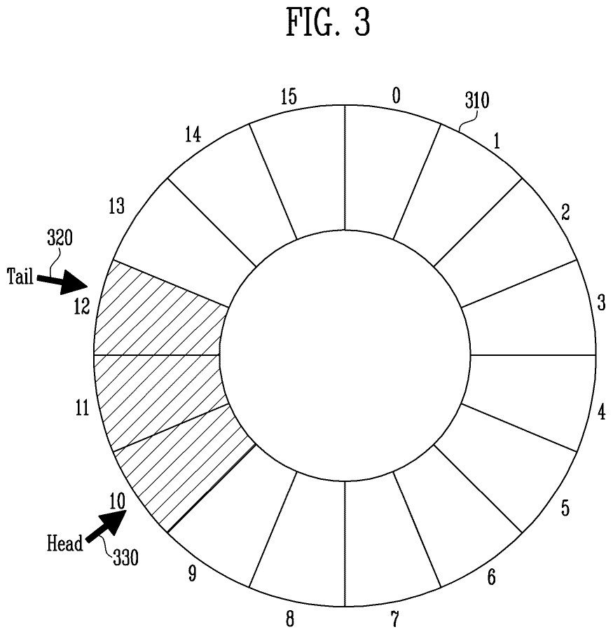

FIG. 3 is a diagram illustrating a completion queue and a completion count according to an embodiment of the present disclosure.

Referring to FIG. 3, a completion queue 310 stored in the host memory device 210 may be depicted. The completion queue 310 may have a circular queue structure. The completion queue 310 may include a tail pointer 320 indicating a tail value and a head pointer 330 indicating a head value.

The completion queue 310 may store completion commands for which operations have been completed by the memory device 120. The completion commands may be sequentially stored in the completion queue 310. The tail value may indicate a completion command stored last in the completion queue 310 among the completion commands. The head value may indicate a completion command stored for a longest time in the completion queue 310 among the completion commands.

In FIG. 3, the completion queue 310 is composed of 16 entries and three completion commands are stored in three entries, respectively. In FIG. 3, values respectively corresponding to 16 entries are illustrated, and the head value and the tail value may be determined among the values respectively corresponding to the 16 entries. The completion command indicated by the head pointer 330 is the oldest completion command stored in the completion queue 310. The completion command indicated by the tail pointer 320 is the most recently stored completion command in the completion queue 310. When the host memory device 210 receives a new completion signal from the completion signal manager 111, the tail pointer 320 is moved, and a new completion command may be stored in the completion queue 310.

In FIG. 3, three completion commands may be successively stored in entries from a tenth entry to a twelfth entry. A value corresponding to the tenth entry may be 10, and a value corresponding to the eleventh entry may be 11. Hereinafter, the case where completion commands are already stored in the tenth and eleventh entries, and a new completion command is currently stored in the twelfth entry is described.

Before the new completion command is stored in the twelfth entry, the head pointer 330 indicates a head value of 10 and the tail pointer 320 indicates a tail value of 11. When the new completion command is stored in the twelfth entry, the head value indicated by the head pointer 330 is the same as 10, but the tail value indicated by the tail pointer 320 changes to 12 that is the value corresponding to the twelfth entry. That is, whenever a new completion command is stored in the completion queue 310, the tail value may increase, and the head value may be maintained.

The interrupt signal generator 112 may obtain a completion count indicating the number of completion commands stored in the completion queue 310 during a preset time interval. The interrupt signal generator 112 may obtain the completion count based on the tail value of the completion queue 310 and the head value of the completion queue 310. For example, the interrupt signal generator 112 may determine a difference between the tail value and the head value to be the completion count.

When the completion operation is performed in response to reception of the interrupt signal by the host device 200, all of the completion commands stored in the completion queue 310 may be deleted. In FIG. 3, when the host device 200 receives the interrupt signal, all of the completion commands stored in the tenth, eleventh, and twelfth entries may be deleted from the completion queue 310, and the tail pointer 320 and the head pointer 330 may indicate 12 which is the value corresponding to the twelfth entry. The completion queue 310 illustrated in FIG. 3 is only an example, and the size and structure of the completion queue 310 may be changed.

In an embodiment of the present disclosure, the completion count may indicate the time during which the corresponding completion command stays in the completion queue 310 or the delay time of the completion operation. As the completion operation is delayed, the completion count may be increased, or the time during which the completion command stays in the completion queue 310 may be lengthened. The host device 200 may process the completion commands based on the interrupt signal of triggering the completion operation on the completion commands. The interrupt signal generator 112 may process the completion commands at one time by delaying the completion operation of the host device 200, thus increasing the data throughput of the host device 200.

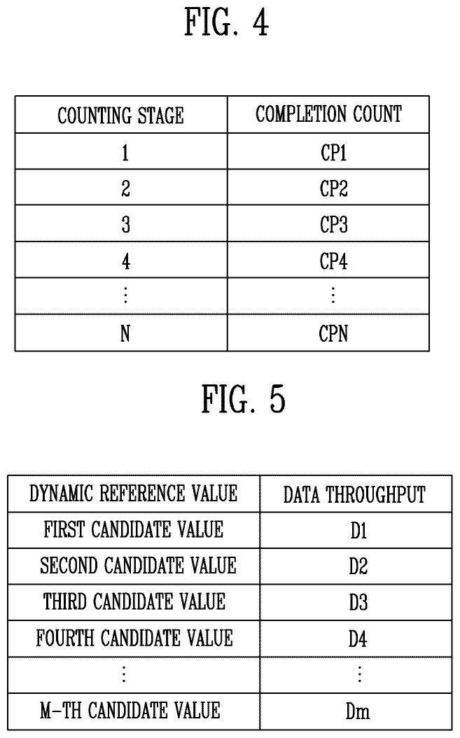

FIG. 4 is a table for describing a dynamic reference value that is set based on a completion count according to an embodiment of the present disclosure.

Referring to FIG. 4, a counting operation of obtaining a completion count may be performed N times. FIG. 4 illustrates a table in which completion counts CP1 to CPN which are obtained in respective counting stages are stored. The counting operation may be performed multiple times, and N times are performed in FIG. 4.

The interrupt signal generator 112 may count the number of completion commands, stored in the completion queue 310, during a preset time interval. In an embodiment of the present disclosure, the interrupt signal generator 112 may dynamically determine the average value or median value of the completion counts CP1 to CPN to be a dynamic reference value based on the result of counting. In an embodiment of the present disclosure, the interrupt signal generator 112 may dynamically determine, as the dynamic reference value, the maximum value of the completion counts CP1 to CPN.

FIG. 5 is a table for describing a method of setting a dynamic reference value based on data throughput corresponding to each candidate value according to an embodiment of present disclosure.

Referring to FIG. 5, the number of preset candidate values for the dynamic reference value may be M. FIG. 5 illustrates a table in which data throughput values D1 to Dm of the host device 200, respectively corresponding to candidate values, are stored.

The interrupt signal generator 112 may temporarily set respective candidate values as reference values. The interrupt signal generator 112 may generate a table in which the data throughput values D1 to Dm of the host device 200, respectively corresponding to the candidate values, are stored during the runtime of the memory system 10. The interrupt signal generator 112 may dynamically determine, as the dynamic reference value, a candidate value at which data throughput is maximized among the preset candidate values.

In an embodiment of the present disclosure, during the runtime of the memory system 10, data throughput values of the host device 200, respectively corresponding to the candidate values, may vary. The interrupt signal generator 112 may update the table in which the data throughput values D1 to Dm of the host device 200, respectively corresponding to the candidate values, are stored, with the lapse of a preset time, and may change the dynamic reference value to one of the preset candidate values based on the updated table.

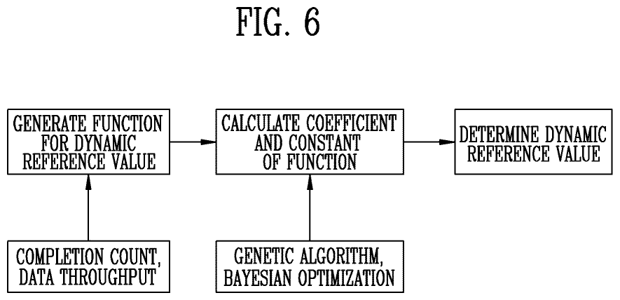

FIG. 6 is a diagram illustrating a method of determining a dynamic reference value using a function that uses a completion count as the variable of the dynamic reference value according to an embodiment of the present disclosure.

Referring to FIG. 6, the interrupt signal generator 112 may dynamically set a reference value for optimizing the data throughput of the host device 200 based on a completion count and the data throughput of the host device 200.

The interrupt signal generator 112 may generate a linear function that uses the completion count as the variable of a dynamic reference value. The generated linear function is described below.

$$DR = a * CP + b$$

Here, DR may be the dynamic reference value, and CP may be the completion count. “a” may be the coefficient of the completion count, and “b” may be a constant. CP may be a natural number, and each of DR, “a”, and “b” may be a rational number. The coefficient of the completion count may refer to the slope of the linear function. When “a” is a positive number, the dynamic reference value increases as the completion count increases, whereas when “a” is a negative number, the dynamic reference value decreases in response to an increase in the completion count.

The interrupt signal generator 112 may calculate the coefficient and the constant of the completion count at which the data throughput of the host device 200 is maximized, through iterative attempts. In an embodiment of the present disclosure, the interrupt signal generator 112 may calculate the coefficient and constant of the completion count based on a genetic algorithm (GA) that utilizes non-dominated ranking and crowding distance ranking.

In an embodiment of the present disclosure, as the genetic algorithm, a non-dominated sorting genetic algorithm (NSGA) II may be used. The interrupt signal generator 112 may initially generate a parent population. The coefficient a and the constant b of the linear function included in the parent population may be arbitrary values. Data throughput for the parent population may be measured. The measured data throughput may exhibit the performance of the parent population.

The result of performance measurement may be sorted based on non-dominated sorting or crowding distance sorting. The non-dominated sorting may be a method of sorting Pareto fronts for respective groups by repeating an operation of searching for a Pareto front and again searching a group from which the found Pareto front is removed for a Pareto front. The crowding distance sorting may be a method of assigning higher priority to the result value of performance measurement that is more sparse in the same Pareto group.

The interrupt signal generator 112 may generate a new parent population that is changed by a predefined size. That is, the coefficient a and the constant b of the linear function included in the parent population may be increased or decreased by a predefined magnitude. The interrupt signal generator 112 may generate a descendant population corresponding to the parent population based on the genetic algorithm. The genetic algorithm that is used may be one of a tournament selection, cross over, or a mutation algorithm. Data throughput for the descendant population may be measured. Similar to the parent population, the measured data throughput may exhibit the performance of the descendant population.

The interrupt signal generator 112 may sort the performance measurement results, and may generate another parent population. The interrupt signal generator 112 may repeat the above-described procedure until the coefficient and constant of the completion count at which data throughput is maximized are found.

In an embodiment of the present disclosure, the interrupt signal generator 112 may calculate the coefficient and the constant of the completion count based on a Bayesian optimization technique. The Bayesian optimization technique uses an acquisition function of detecting the coefficient and the constant of the completion count at which the data throughput of the host device 200 is increased based on a surrogate model for improving the coefficient and the constant of the completion count based on a Gaussian process and the probability distribution of the surrogate model.

The interrupt signal generator 112 may create the surrogate model for the dynamic reference value on the assumption that the dynamic reference value determined based on the coefficient a and the constant b of the linear function is determined by the Gaussian process. The interrupt signal generator 112 may randomly determine the coefficient a and the constant b of the linear function, and may check dynamic reference values depending on the determined coefficient a and constant b of the linear function.

Based on the checked dynamic reference values, the coefficient a and the constant b of the linear function at which data throughput is higher may be searched for. The interrupt signal generator 112 may identify a candidate dynamic reference value at which the data throughput is the highest among the checked dynamic reference values, and may determine a candidate coefficient and a candidate constant corresponding to the candidate dynamic reference value. The interrupt signal generator 112 may attempt to search an area around the candidate coefficient and the candidate constant for a new candidate coefficient and a new candidate constant at which data throughput is higher than the candidate dynamic reference value. This may be regarded as a first attempt.

Further, the interrupt signal generator 112 may generate a new dynamic reference value corresponding to a new coefficient and a new constant by changing the coefficient a and the constant b of the linear function. Candidate values for the coefficient a and the constant b of the linear function may be determined by checking data throughput based on the new dynamic reference value. This may be regarded as a second attempt.

The interrupt signal generator 112 may change the coefficient a and the constant b of the linear function by selecting one of the first attempt and the second attempt using the acquisition function, thus repeatedly acquiring the dynamic reference value. The acquisition function may be a function of selecting an attempt method capable of obtaining a result better than the current result based on the probability distribution of the surrogate model. The interrupt signal generator 112 may determine the coefficient a and the constant b of the linear function at which data throughput is increased by checking data throughput corresponding to the acquired dynamic reference value. The interrupt signal generator 112 may determine the dynamic reference value at which data throughput is maximized by repeating the change of the coefficient a and the constant b of the linear function.

The interrupt signal generator 112 may calculate the coefficient and the constant of the function that uses the completion count as the variable of the dynamic reference value, and may determine the dynamic reference value based on the calculated coefficient and constant.

In the specification of the present disclosure, although the generated function is a linear function for convenience of description, the interrupt signal generator 112 may generate a polynomial function.

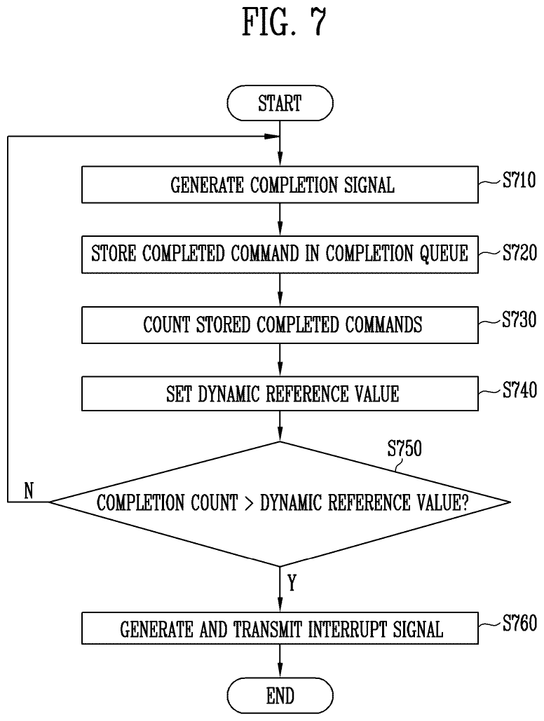

FIG. 7 is a flowchart illustrating a method of transmitting an interrupt signal based on a dynamic reference value according to an embodiment of the present disclosure.

Referring to FIG. 7, the memory controller may store a command for which execution has been completed by the memory device in the completion queue of the host device. Further, the memory controller may transmit an interrupt signal for triggering a completion operation on the completion command stored in the completion queue to the host device. Furthermore, the memory controller may transmit the interrupt signal by dynamically setting the number of completion commands for which a completion operation is performed to optimize the data throughput of the host device.

At S710, the completion signal manager may generate a completion signal indicating completion of an operation corresponding to a command received from the host device. At S720, the completion signal manager may transmit the completion signal to the host device, and the host device may store the command in the completion queue stored in the host device based on the completion signal. The command stored in the completion queue may be the completion command for which the corresponding operation has been completed. In the completion queue, a plurality of completion commands may be stored.

At S730, the interrupt signal generator may obtain a completion count which is the number of completion commands stored in the completion queue. A counting operation for the completion count may correspond to the description of FIG. 3.

At S740, the interrupt signal generator may set a dynamic reference value based on the completion count and the data throughput of the host device. According to the dynamic reference value, the completion commands stored in the completion queue are processed to be complete. The method by which the interrupt signal generator sets the dynamic reference value may correspond to the description of FIGS. 4 to 6.

At S750, the interrupt signal generator may compare the completion count with the dynamic reference value. When it is determined that the completion count exceeds the dynamic reference value (S750, Y), the process may proceed to S760. When it is determined that the completion count is less than or equal to the dynamic reference value (S750, N), an interrupt signal may not be generated, and the process may return to S710.

At S760, the interrupt signal generator may generate an interrupt signal for triggering the completion operation on the completion commands. The interrupt signal generator may transmit the interrupt signal to the host device.

The description of individual operations of FIG. 7 may correspond to that of FIG. 2.

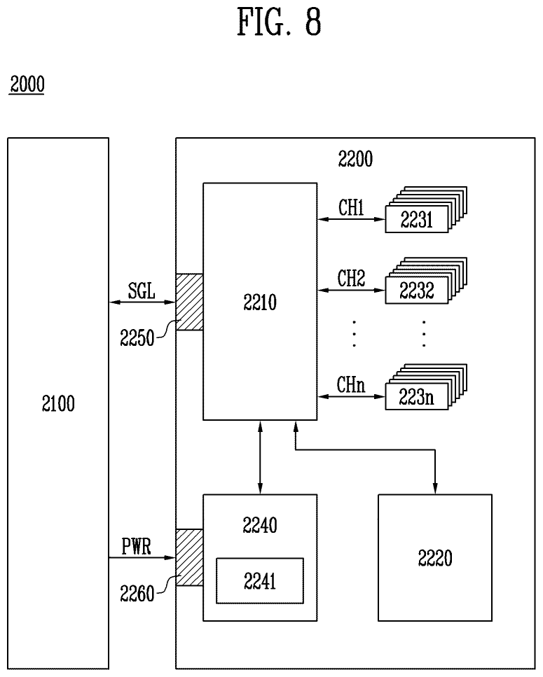

FIG. 8 is a diagram illustrating a memory system including a memory controller according to an embodiment of the present disclosure.

Referring to FIG. 8, a memory system 2000 may include a host device 2100 and a solid state drive (SSD) 2200.

In an embodiment of the present disclosure, the host device 2100 may store a completion queue in which completion commands for which operations have been completed are stored. The host device 2100 may maintain the completion commands in the completion queue until a completion operation on the completion commands is performed.

The SSD 2200 may include a controller 2210, a buffer memory device 2220, nonvolatile memories 2231 to 223n, a power supply 2240, a signal connector 2250, and a power connector 2260.

The buffer memory device 2220 may temporarily store data to be stored in the nonvolatile memories 2231 to 223n. Also, the buffer memory device 2220 may temporarily store data read from the nonvolatile memories 2231 to 223n. The data temporarily stored in the buffer memory device 2220 may be transmitted to the host device 2100 or the nonvolatile memories 2231 to 223n under the control of the controller 2210.

The nonvolatile memories 2231 to 223n may be used as storage media of the SSD 2200. The nonvolatile memories 2231 to 223n may be coupled to the controller 2210 through a plurality of channels CH1 to CHn, respectively. One or more nonvolatile memories may be coupled to one channel. The nonvolatile memories coupled to one channel may be coupled to the same signal bus and the same data bus.

The controller 2210 may control the overall operation of the SSD 2200. In an embodiment of the present disclosure, the controller 2210 may transmit, to the host device 2100, a completion signal indicating a command for which execution is completed by the SSD 2200. The controller 2210 may generate an interrupt signal for triggering a completion operation on the completion commands of the host device 2100. The controller 2210 may dynamically set a reference value for the interrupt signal based on a completion count which is the number of completion commands stored in the completion queue during a preset time interval, and the data throughput of the host device 2100. The controller 2210 may adjust the number of completion commands stored in the completion queue by dynamically setting the reference value for the interrupt signal.

The power supply 2240 may provide power PWR received through the power connector 2260 into the SSD 2200. The power supply 2240 may include an auxiliary power supply 2241. When a sudden power-off occurs, the auxiliary power supply 2241 may supply power so that the SSD 2200 normally shuts off. The auxiliary power supply 2241 may include large-capacity capacitors capable of charging power PWR.

The controller 2210 may exchange a signal SGL with the host device 2100 through the signal connector 2250. Here, the signal SGL may include a command, an address, data, etc. The signal connector 2250 may be implemented as various types of connectors depending on the interface scheme between the host device 2100 and the SSD 2200.

According to the embodiments of the present disclosure, there can be provided a memory system that is capable of improving the data throughput of a host device by dynamically setting a reference value for an interrupt signal that is transferred to a host device, and a method of setting a dynamic reference value for the interrupt signal.

The scope of the present disclosure is defined by the accompanying claims, rather than by the detailed description, and all modifications or changes derived from the meaning and scope of the claims and equivalents thereof should be construed as falling within the scope of the present disclosure. Furthermore, the embodiments may be combined to form additional embodiments.

What is claimed is:

1. A memory system comprising:
a host device configured to generate a command, and including a completion queue in which completion commands for which operations have been completed are stored;
a memory controller configured to receive the command and generate a control signal corresponding to the command; and
a memory device configured to perform an operation corresponding to the command in response to the control signal,
wherein the memory controller comprises:
a completion signal manager configured to generate a completion signal indicating completion of the operation corresponding to the command and control the host device to store the command in the completion queue based on the completion signal; and
an interrupt signal generator configured to obtain a completion count which is a number of completion commands stored in the completion queue during a preset time interval, set a dynamic reference value based on the completion count and data throughput of the host device such that the completion commands stored in the completion queue are processed to be complete based on the dynamic reference value, generate an interrupt signal for triggering a completion operation on the completion commands in response to a case where the completion count exceeds the dynamic reference value, and transmit the interrupt signal to the host device, and
wherein the host device performs the completion operation on the completion commands stored in the completion queue in response to the interrupt signal.

2. The memory system according to claim 1, wherein:
the memory device is configured to transfer, to the memory controller, a result of performing the operation corresponding to the command, and
the memory controller is configured to transfer, to the host device, the completion signal in response to a case where the result of performing the operation indicates completion of the operation.

3. The memory system according to claim 2, wherein the host device is configured to store, in the completion queue, the command corresponding to the completion signal, as one of the completion commands.

4. The memory system according to claim 1, wherein the host device is configured to terminate processes corresponding to the completion commands stored in the completion queue.

5. The memory system according to claim 2, wherein the host device is configured to delete the completion commands stored in the completion queue.

6. The memory system according to claim 1, wherein:
the interrupt signal generator is configured to determine, as the completion count, a difference between a tail value of the completion queue and a head value of the completion queue,
the tail value indicates a completion command stored last in the completion queue among the completion commands, and
the head value indicates a completion command stored for a longest time in the completion queue among the completion commands.

7. The memory system according to claim 1, wherein the interrupt signal generator is configured to perform a counting operation for the completion count multiple times, and determine, as the dynamic reference value, an average value or a maximum value of the completion count based on a result of the counting operation.

8. The memory system according to claim 1, wherein the interrupt signal generator is configured to determine, as the dynamic reference value, among preset candidate values, a candidate value at which the data throughput corresponding to each of the candidate values is maximized.

9. The memory system according to claim 1, wherein the interrupt signal generator is configured to set a variable of the dynamic reference value to the completion count, calculate a coefficient and a constant of the variable at which the data throughput is maximized through iterative attempts, and determine the dynamic reference value corresponding to the completion count based on the calculated coefficient and constant.

10. The memory system according to claim 9, wherein:
the interrupt signal generator is configured to calculate the coefficient and the constant of the variable based on a genetic algorithm, and
the genetic algorithm determines optimal values of the coefficient and the constant of the variable using non-dominated ranking and crowding distance ranking.

11. The memory system according to claim 9, wherein:
the interrupt signal generator is configured to calculate the coefficient and the constant of the variable based on a Bayesian optimization technique, and
the Bayesian optimization technique determines optimal values for the coefficient and the constant of the variable using an acquisition function of detecting the coefficient and the constant of the variable at which the data throughput is increased based on a surrogate model for improving the coefficient and constant of the variable based on a Gaussian process and a probability distribution of the surrogate model.

12. A memory controller comprising:
a completion signal manager configured to generate a completion signal indicating completion of an operation corresponding to a command received from a host device, and control the host device to store the command in a completion queue stored in the host device in response to the completion signal; and
an interrupt signal generator configured to set a dynamic reference value based on data throughput of the host device, such that completion commands stored in the completion queue are processed to be complete based on the dynamic reference value, generate an interrupt signal for triggering a completion operation on the completion commands based on the dynamic reference value, and transmit the interrupt signal to the host device.

13. The memory controller according to claim 12, wherein the interrupt signal generator is configured to obtain a completion count that is a number of completion commands stored in the completion queue during a preset time interval and generate the interrupt signal in response to the completion count exceeding the dynamic reference value.

14. The memory controller according to claim 13, wherein:
the interrupt signal generator is configured to determine, as the completion count, a difference between a tail value of the completion queue and a head value of the completion queue,
the tail value indicates a completion command stored last in the completion queue among the completion commands, and
the head value indicates a completion command stored for a longest time in the completion queue among the completion commands.

15. The memory controller according to claim 13, wherein the interrupt signal generator is configured to perform a counting operation for the completion count multiple times, and determine, as the dynamic reference value, an average value or a maximum value of the completion count based on a result of the counting operation.

16. The memory controller according to claim 13, wherein the interrupt signal generator is configured to determine, as the dynamic reference value, among preset candidate values, a candidate value at which the data throughput corresponding to each of the candidate values is maximized.

17. The memory controller according to claim 13, wherein the interrupt signal generator is configured to set the dynamic reference value corresponding to the completion count based on the data throughput.

18. The memory controller according to claim 17, wherein the interrupt signal generator is configured to set a variable of the dynamic reference value as the completion count and calculate a coefficient and a constant of the variable at which the data throughput is maximized through iterative attempts.

19. The memory controller according to claim 18, wherein:
the interrupt signal generator is configured to calculate the coefficient and the constant of the variable based on a genetic algorithm, and
the genetic algorithm determines optimal values of the coefficient and the constant of the variable using non-dominated ranking and crowding distance ranking.

20. The memory controller according to claim 18, wherein:
the interrupt signal generator is configured to calculate the coefficient and the constant of the variable based on a Bayesian optimization technique, and
the Bayesian optimization technique determines optimal values for the coefficient and the constant of the variable using an acquisition function of detecting the coefficient and the constant of the variable at which the data throughput is increased based on a surrogate model for improving the coefficient and constant of the variable based on a Gaussian process and a probability distribution of the surrogate model.
